(19) United States
(12) Patent Application Publication
(10) Pub. No.: US 2025/0125327 A1
(43) Pub. Date: Apr. 17, 2025

(54) CURRENT COLLECTOR MATING

(71) Applicant: Our Next Energy, Inc., Novi, MI (US)

(72) Inventors: Peyman James Sirous, Freemont, CA (US); Qingcheng Zeng, Freemont, CA (US); Julie Goetz, Freemont, CA (US)

(21) Appl. No.: 18/913,770

(22) Filed: Oct. 11, 2024

Related U.S. Application Data
(60) Provisional application No. 63/589,608, filed on Oct. 11, 2023.

(51) Int. Cl. H01M 4/04; H01M 4/66; H01M 50/536

(52) U.S. Cl. CPC H01M 4/0404; H01M 4/0419; H01M 4/661; H01M 50/536

(57) ABSTRACT

A method including melting a metallic material, converting the metallic material into an aerosolized metal spray, reducing a temperature of the aerosolized metal spray from a first temperature to a second temperature by generating a temperature gradient for transmission of the aerosolized metal spray, and transmitting the aerosolized metal spray through or using the temperature gradient. In the method a substrate is coated with the aerosolized metal spray prior to solidification of the aerosolized metal spray to form a solidified metal-to-substrate bond, which is a mechanical and an electrical bond.

### BACKGROUND

### Technical Field

The present disclosure generally relates to mating of current collectors and more particularly to using a metal spray or molten metal to bond parts of a substrate, including a plurality of current collectors, together to form a mechanical and an electrical bond.

### Description of the Related Art

A typical battery is made up of many cells, each of which may comprise an anode current collector, anode, separator, cathode, and cathode current collector. The anode and cathode may form the electrodes of the cell, and electrode-to-busbar interconnections within the cell assist in providing efficient electrical performance for electric vehicles, energy storage systems, and other devices. A quality of mating between interface connections may influence contact resistances, bond degradation, and battery performance.

### BRIEF SUMMARY

According to an embodiment of the present invention, a method is disclosed. The method includes melting a metallic material, converting the metallic material into an aerosolized metal spray, reducing a temperature of the aerosolized metal spray from a first temperature to a second temperature by generating a temperature gradient for transmission of the aerosolized metal spray, and transmitting the aerosolized metal spray through or using the temperature gradient. In the method, a substrate is coated with the aerosolized metal spray prior to solidification of the aerosolized metal spray to form a solidified metal-to-substrate bond, which is a mechanical and an electrical bond.

In one embodiment, the temperature gradient is generated using a gaseous curtain.

In one embodiment, the temperature gradient is generated using an intermediate material.

According to an embodiment, a cell is disclosed. The cell includes a substrate that includes a pair of cathode active material layers and a current collector disposed between the pair of cathode active material layers. The cell further includes a solidified metal spray coating a first side of the substrate in a solidified metal-to-substrate bond in which the solidified metal-to-substrate bond is a mechanical and an electrical bond and bonds at least the current collector to other current collectors and/or to one or more external tabs.

According to an embodiment, a cell is disclosed. The cell includes a substrate that includes a pair of cathode active material layers and a current collector disposed between the pair of cathode active material layers and projecting beyond a first edge of the pair of cathode active material layers. The cell also includes at least one external tab disposed at one side of the substrate. The cell also includes a mating cavity formed in the external tab and the current collector with a solidified molten metal disposed in the mating cavity to bond the current collector to the external tab in a mechanical and an electrical bond.

### BRIEF DESCRIPTION OF THE DRAWINGS

To easily identify the discussion of any particular element or act, the most significant digit or digits in a reference number refer to the figure number in which that element is first introduced.

FIG. 1 depicts a cross-section of a substrate in accordance with an illustrative embodiment.

FIG. 2 depicts a perspective view showing a first side of a substrate in accordance with an illustrative embodiment.

FIG. 3 depicts a cross-section of a first side of a substrate along with an intermediate material in accordance with an illustrative embodiment.

FIG. 4 depicts a cross-section of a first side of a substrate along with an intermediate tab in accordance with an illustrative embodiment.

FIG. 5 depicts a cross-section of a first side of a substrate along with an external tab in accordance with an illustrative embodiment.

FIG. 6 depicts a cross-section of a first side of a substrate along with a pair of external tabs in accordance with an illustrative embodiment.

FIG. 7 depicts a cross-section of a substrate along a solidified molten metal bond in accordance with an illustrative embodiment.

FIG. 8 depicts a routine in accordance with an illustrative embodiment.

FIG. 9 depicts a functional block diagram of a computer hardware platform in accordance with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below”, or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” or “electrically bonded” refers to a low-ohmic electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein. In particular, various steps in the manufacture of cells are well known and so, in the interest of brevity, many conventional steps will only be mentioned briefly herein or will be omitted entirely without providing the well-known process details.

Turning now to an overview of technologies that generally relate to the present teachings, it is recognized that cells, regardless of their specific application, may rely on the efficient transfer of charge between active materials and external electrical circuits. Current collectors may serve as the cell components that facilitate charge transfer by providing a conductive pathway between the active materials and the external electrical terminals. The illustrative embodiments recognize that current collectors may be assembled within the cell based on intricate welding, soldering, or mechanical connections, which can introduce various challenges including damaging of cell components, introduction of mechanical stress, introduction of additional resistance leading to energy losses and heat generation, and ultimately reduction of the electrical conductivity due to the high electrical resistance.

The illustrative embodiments disclose a current collector mating process comprising melting a metallic material, converting the metallic material into an aerosolized metal spray, and spraying the aerosolized metal spray on a side of a cell where a plurality of current collectors and at least a tab are exposed to electrically and mechanically components of the cell, including at least the current collectors and tab, together. To alleviate or eliminate damages to components of the cell, this may be performed by reducing a temperature of the aerosolized metal spray from a first temperature of the metallic material (e.g., the melting point temperature of the metallic material) to a second temperature by generating a temperature gradient for transmission of the aerosolized spray, transmitting the aerosolized metal spray through the temperature gradient, and coating a substrate with the aerosolized metal spray prior to solidification of the aerosolized metal spray to form at least a solidified metal-to-substrate bond. The second temperature is lower than a melting point or predetermined handling temperature of a material of the substrate.

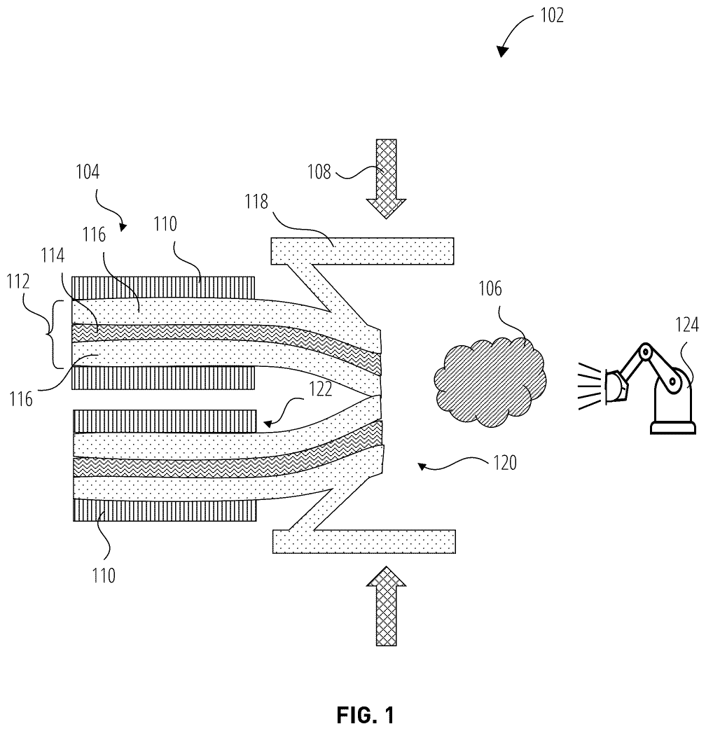

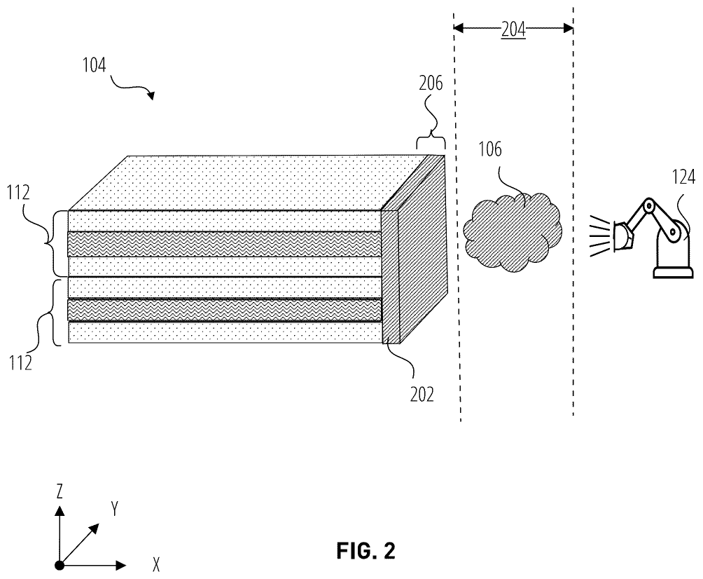

FIG. 1 illustrates a cell in accordance with an illustrative embodiment. The cell may comprise a substrate 104 comprising a pair of cathode active material layers 110 and a current collector 112 disposed between the pair of cathode active material layers 110. The cell 102 may further comprise a solidified metal spray 202 (See FIG. 2) that coats a first side 120 of the substrate 104 to form a solidified metal-to-substrate bond 206. The solidified metal-to-substrate bond 206 is a mechanical and an electrical bond.

The cell 102 may be formed by a method that comprises melting a metallic material, converting the melted metallic material into an aerosolized metal spray, and coating, using a spray device 124, the substrate 104 with the aerosolized metal spray prior to solidification of the aerosolized metal spray to form a solidified metal-to-substrate bond. As used herein, the term “metallic material” generally refers to a metal such as Al, Ni, Cu, and Stainless steel, or alloy that can electrically and mechanically bond parts of a cell together.

In an aspect, the plurality of current collectors 112 may be metallized polymer current collectors which each include a polymer layer 114 such as polyethylene terephthalate (PET) or a polyimide, as well as two metal layers 116 within which the polymer layer 114 is disposed. The metal layers 116 can comprise a metal such as Al, Ni, Cu, or Stainless Steel. In another aspect, the current collector can be a metal foil.

Due to the ability of high temperatures to damage current collectors 112 and cell components in general, the temperature of the melted metallic material or aerosolized metal spray 106 which may be significantly higher than a melting point or safe handling temperature of current collectors 112 or cell components, may be reduced to enable safe bonding. Thus, techniques for reducing a temperature of the aerosolized metal spray 106 prior to coating the aerosolized metal spray on the substrate 104 to bond cell components together are disclosed herein.

In an aspect, the temperature of the aerosolized metal spray is reduced from a first temperature, such as a melting point temperature of the metallic material, to a second lower temperature that is lower than a melting point or predetermined handling temperature of the current collector 112 or cell components by generating a temperature gradient for transmission of the aerosolized spray and transmitting the aerosolized metal spray through or using the temperature gradient. Thus, the substrate 104 can be coated with the aerosolized metal spray 106 prior to solidification of the aerosolized metal spray 106 to bond at least the plurality of current collectors 112 and/or external tabs 118 together form the solidified metal-to-substrate bond 206. In an aspect, a press 108 may be used to press the current collectors 112 (which may project beyond the first edge 122) and the external tab 118 together while applying the aerosolized metal spray 106. The temperature gradient may in an aspect be a gaseous curtain 204 or an intermediate material 302 as described herein.

Due to some current collectors 112, in particular, some polymers of some metallized polymer current collectors 112 not being able to melt and, instead burning at high temperatures, the second temperature may be kept at below a predetermined handling temperature. Thus, the temperature of the substrate 104 may be monitored to ensure it does not reach a value that causes it to get damaged. For example, PET may be kept at below 118° C. during coating of the aerosolized metal spray 106, to ensure the PET doesn't get damaged.

In an illustrative embodiment, the aerosolized metal spray 106 comprises aluminum. When sprayed the aerosolized metal spray 106 is aluminum liquid, and upon drying, it becomes metallic aluminum. Aluminum may melt at about 660 degrees Celsius while PET in a metallized polymer current collector comprising PET may melt at about 260 degrees Celsius. Thus, to achieve proper coating of, for example, up to 4 mm, the illustrative embodiments recognize that the substrate or PET may be kept below its melting temperature through a thermal load optimization that is significantly challenging. One reason is that oxidation may reduce the conductivity of the bond. Further, there may be material limitations because some materials may not work well with electrolytes in a battery application and unchecked porosity may cause safety issues such as explosions due to gaps created. Oxidation and porosity may cause resistances to increase, which is unwanted in the cell or battery. Thus, the illustrative embodiments optimize for spray film roughness, the oxidation state, spray film porosity, and size of the droplets that may prevent shorts in between the layers of the cell while taking into consideration the material and temperature limitations of cell components.

FIG. 2 illustrates a perspective view showing a first side 120 of the substrate 104 and a temperature gradient configured as a gaseous curtain 204. The substrate 104 is part of the cell 102, and the cell comprises a housing (not shown) with a profile that is parallel to the YX-plane, the YX-plane being a two-dimensional plane in three-dimensional space that is perpendicular to the Z-axis. More specifically, the YX-plane is a two-dimensional plane in three-dimensional space that is perpendicular to a surface of the cell through which the tab of FIG. 1 passes from inside the housing to be exposed outside the housing.

Upon generating the temperature gradient as a gaseous curtain 204, the aerosolized metal spray through the gaseous curtain 204 to reduce the temperature of the aerosolized metal spray 106 to the second temperature, or the aerosolized metal spray is transported towards the first side 120 to coat the substrate 104 using the gaseous curtain 204.

The gaseous curtain 204 may be an inert gas current (such as one comprising Argon, Nitrogen, or other inert gases). This may prevent oxidation of the aerosolized metal spray and may cool it to lower temperatures. The curtain can be directed towards the substrate (i.e., helping the aerosolized metal spray reach the target) in one aspect, or in other directions in another aspect to control a total cooling time and a temperature profile. The total cooling time or a timed sequence, and cooling directions may thus be a factor of the desired second temperature as well as the initial temperature of the aerosolized metal spray 106 (the first melting point temperature).

As seen in FIG. 2, the aerosolized metal spray 106 solidifies into the solidified metal spray 202 upon application to the substrate to form a solidified metal-to-substrate bond 206. The solidified metal spray may comprise a thickness (in the X-axis direction, in the case of FIG. 2) from 100 μm to 10 mm, or from 10 μm to 5 mm, or from 1 μm to 1 mm.

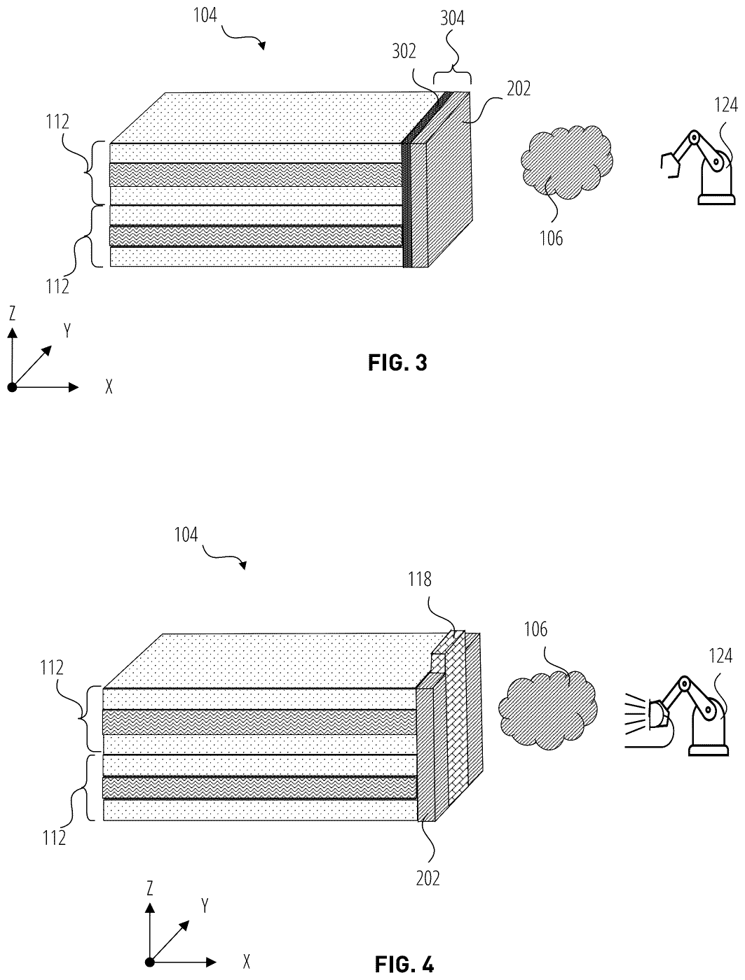

FIG. 3 illustrates a perspective view showing a first side 120 of the substrate 104 and a temperature gradient configured as an intermediate material 302. More specifically, the temperature gradient is generated for transmission of the aerosolized metal spray through use of the intermediate material 302 by attaching or coating onto the substrate 104 the intermediate material 302 which has a predetermined thermal conductivity or heat tolerance that is chosen to enable the intermediate material 302 to withstand heat from applied aerosolized metal spray 106 and to reduce the temperature of the aerosolized metal spray 106 to a temperature that is determined to be safe for the substrate 104 prior to the aerosolized metal spray 106 reaching the substrate 104 or prior to any temperature changes in the substrate 104 caused by the aerosolized metal spray 106 reaching a predetermined damage inducing level. In an aspect, a predetermined damage inducing level is a temperature within 20%, or 10%, or 5% of the melting point or a safe handling temperature of the substrate 104. This forms the solidified metal-to-substrate bond 206, which in this case is a solidified metal-to-intermediate material-to-substrate bond. In an example, the intermediate material 302 may comprise a coating of metal or alloy such as Zinc, Tin or a Zinc-Aluminum alloy. In another aspect, the intermediate material 302 comprises a melting temperature that is higher than that of PET, but lower than that of the aerosolized metal spray. For example, zinc or Tin may be to ensure that when the droplets land on the PET, the droplets cause little to no thermal damage. After the intermediate material is deposited, the aerosolized metal spray can be applied, with the intermediate material acting as a temperature gradient to protect the PET from thermal damage.

In an aspect, the use of the intermediate material 302 as a temperature gradient may be combined with the use of the gaseous curtain 204 as another temperature gradient to reduce the temperature of the aerosolized metal spray 106 from the first melting point temperature to the second temperature. Generally, design of experiment tests may be conducted on the basis of the second temperature being a factor of at least one of the total cooling time, the timed cooling sequence, the gaseous curtain specifications such as direction and dimensions, and the intermediate material specifications such as dimensions, heat tolerance, and material type. This allows the selection of specific parameters for use in performing tailored current collector mating procedures.

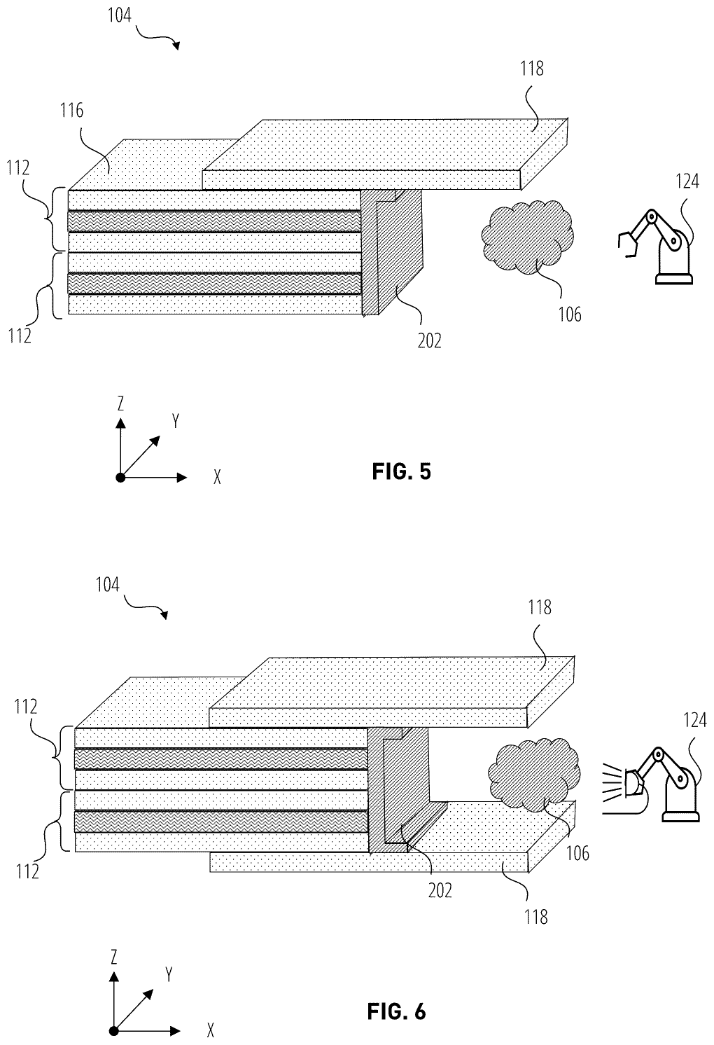

FIG. 4 and FIG. 5 depict a cross-section of the substrate 104 illustrating external tabs 118 in accordance with an illustrative embodiment. In FIG. 4, the external tab 118 is parallel to the ZY-plane and the solidified metal spray 202 surrounds at least a periphery of the external tab 118. This may be achieved by bonding the external tab 118 to the substrate 104 at the first side 120 by placing the external tab 118 at the first side prior to coating the substrate with the aerosolized metal spray. Alternatively, as shown in FIG. 5, the external tab 118 is parallel to the YX-plane and the metal layer 116 is bonded to the external tab 118 via application of the aerosolized metal spray 106 at both the first side 120 and underneath the external tab 118. In an aspect, the metal layer 116 and the external tab 118 may comprise the same material or different materials that are corrosion resistant. As shown in FIG. 6, more than one external tab 118 may be bonded to the substrate 104.

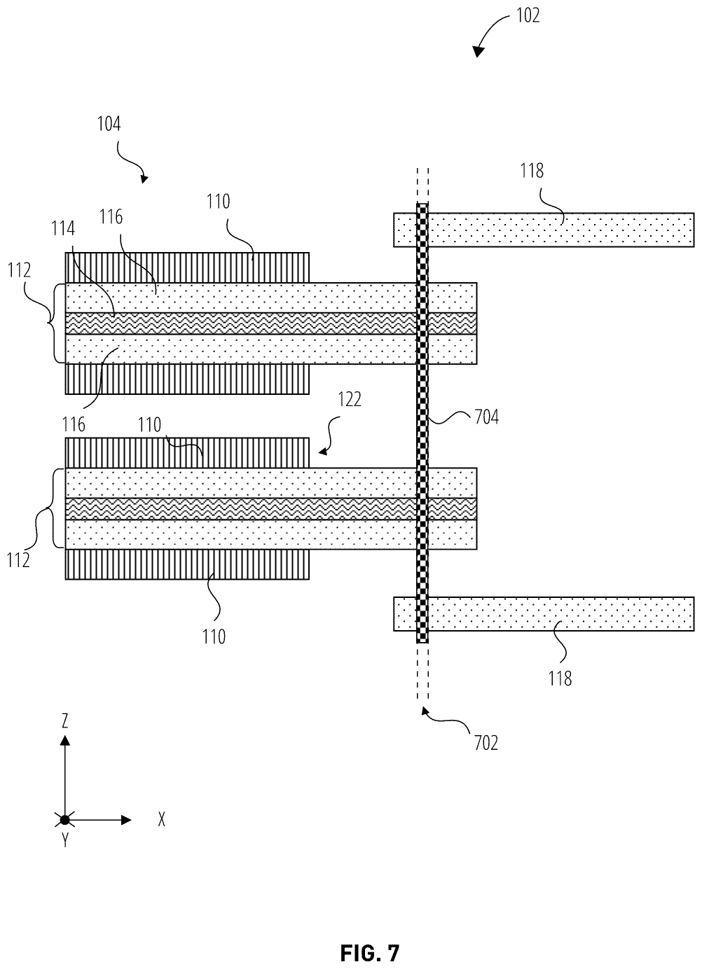

Turning now to FIG. 7, a cross section of a cell comprising a solidified metal-to-substrate bond wherein the bond is formed with molten metal is shown. The cell comprises a substrate that comprises a pair of cathode active material layers 110 and a current collector 112 disposed between the pair of cathode active material layers and projecting beyond a first edge 122 of the pair of cathode active material layers 110. The cell 102 further comprises at least one external tab 118 and a mating cavity 702 formed through the at least one external tab and the current collector 112. A solidified molten metal 704 is disposed in the mating cavity 702 to bond the current collector 112 to the at least one external tab 118 in a mechanical and an electrical bond.

In an aspect, the cell comprises a plurality of current collectors and a mating cavity is formed in the at least one external tab and the plurality of current collectors. The solidified molten metal 704 may be formed, for example, by using a laser to melt a metallic material and disposing the molten metallic material into the mating cavity.

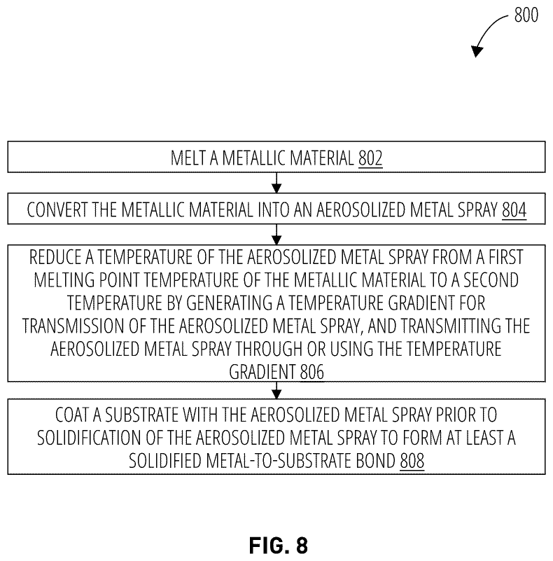

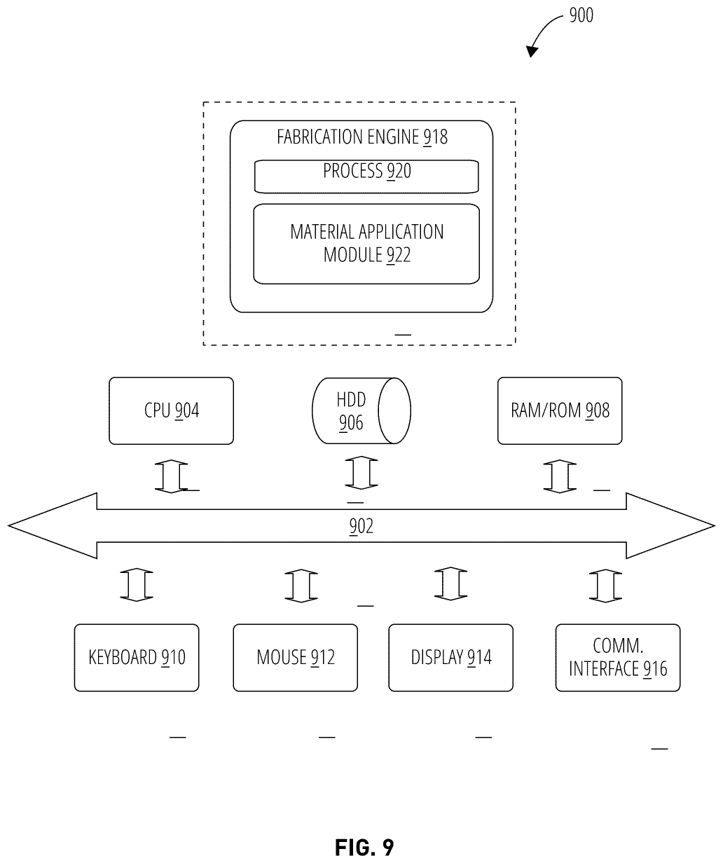

FIG. 8 illustrates a routine 800 in accordance with an embodiment. The routine may be performed by the fabrication engine 918 of FIG. 9. In block 802, fabrication engine 918 melts a metallic material. In block 804, fabrication engine 918 converts the metallic material into an aerosolized metal spray. In block 806, fabrication engine 918 reduces a temperature of the aerosolized metal spray from an initial temperature of the metallic material, such as a melting point temperature to a second temperature by generating a temperature gradient for transmission of the aerosolized metal spray 106 and transmitting the aerosolized metal spray 106 to the substrate 104 through or using the temperature gradient. In block 808, fabrication engine 918 coats the substrate with the aerosolized metal spray prior to solidification of the aerosolized metal spray to form at least a solidified metal-to-substrate bond which is a mechanical and an electrical bond.

As discussed above, functions relating to current collector mating can use of one or more computing devices connected for data communication via wireless or wired communication. FIG. 9 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 900 may include a central processing unit (CPU) 904, a hard disk drive (HDD) 906, random access memory (RAM) and/or read only memory (ROM) 908, a keyboard 910, a mouse 912, a display 914, and a communication interface 916, which are connected to a system bus 902.

In one embodiment, the hard disk drive (HDD) 906, has capabilities that include storing a program that can execute various processes, such as processes of the fabrication engine 918, in a manner described herein. The fabrication engine 918 may have various modules configured to perform different functions. For example, there may be a process module 920 configured to control the different manufacturing processes discussed herein and others. There may be a material application module 922 operable to provide an appropriate melting, aerosolizing, and application the metal spray of molten material.

For the sake of brevity, conventional techniques related to making and using aspects of the disclosure may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted, or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method comprising:
melting a metallic material;
converting the metallic material into an aerosolized metal spray;
generating a temperature gradient;
transmitting the aerosolized metal spray through or using the temperature gradient to reduce a temperature of the aerosolized metal spray from a first temperature to a second temperature; and
coating a substrate with the aerosolized metal spray prior to solidification of the aerosolized metal spray to form at least a solidified metal-to-substrate bond,
wherein the second temperature is lower than a melting point or predetermined handling temperature of a material of the substrate.

2. The method of claim 1, wherein the step of generating the comprises generating a gaseous curtain, and wherein transmitting the aerosolized metal spray through or using the temperature gradient comprises passing the aerosolized metal spray through the gaseous curtain.

3. The method of claim 2, wherein the gaseous curtain comprises an inert gas.

4. The method of claim 1, further comprising:
generating the temperature gradient for transmission of the aerosolized metal spray through use of an intermediate material and attaching or coating onto the substrate the intermediate material that has a predetermined thermal conductivity, the intermediate material being configured to receive at least a part of the transmitted aerosolized metal spray and reduce the temperature of the aerosolized metal spray to the second temperature prior to form the solidified metal-to-substrate bond,
wherein a solidified metal-to-substrate bond is a solidified metal-to-intermediate material-to-substrate bond.

5. The method of claim 1, wherein the solidified metal-to-substrate bond is an electrical and a mechanical bond.

6. The method of claim 1, wherein:
the substrate is formed by disposing a current collector between two cathode active material layers,
the current collector is formed to project beyond a first edge of the two cathode active material layers and
the aerosolized metal spray is coated on a first side of the substrate where the current collector is exposed.

7. The method of claim 6, wherein:
the current collector is a metallized polymer current collector, and the substrate is formed by disposing the metallized polymer current collector between the two cathode active material layers.

8. The method of claim 7, wherein the substrate comprises a plurality of metallized polymer current collectors which are electrically and mechanically connected together at the first side by spraying of the aerosolized metal spray.

9. The method of claim 1, wherein the metallic material comprises Al, Ni, Cu, or Stainless Steel.

10. The method of claim 1, further comprising:
bonding at least one external tab to the substrate at the first side by placing the at least one external tab at the first side prior to coating the substrate with the aerosolized metal spray.

11. A cell comprising:
a substrate comprising:
a pair of cathode active material layers;
a current collector disposed between the pair of cathode active material layers; and
a solidified metal spray coating a first side of the substrate in a solidified metal-to-substrate bond
wherein the solidified metal-to-substrate bond is a mechanical and an electrical bond.

12. The cell of claim 11, wherein the current collector is a metallized polymer current collector, and the substrate is formed by disposing the metallized polymer current collector between the pair of cathode active material layers.

13. The cell of claim 12, wherein:
the metallized polymer current collector includes a polymer layer comprising polyethylene terephthalate (PET) or a polyimide, and two metal layers comprising Al, Ni, Cu, or Stainless Steel, and
the polymer layer is disposed between the two metal layers.

14. The cell of claim 11, wherein the current collector is a metal foil.

15. The cell of claim 11, further comprising:
an intermediate material disposed at the first side in between the substrate and the solidified metal spray and configured to generate a predetermined thermal gradient for solidification of the solidified metal spray.

16. The cell of claim 15, wherein the solidified metal spray comprises is a metal or alloy.

17. The cell of claim 11, further comprising:
at least one external tab bonded to the substrate at the first side via the solidified metal spray.

18. The cell of claim 11, wherein the current collector projects beyond a first edge of the pair of cathode active material layers.

19. The cell of claim 11, wherein a thickness of the solidified metal spray is from 100 μm to 10 mm.

20. A cell comprising:
a substrate comprising:
a pair of cathode active material layers;
a current collector disposed between the pair of cathode active material layers and projecting beyond a first edge of the pair of cathode active material layers; and
at least one external tab disposed at a first side of the substrate;
a mating cavity formed in the at least one external tab and the current collector; and
a solidified molten metal disposed in the mating cavity to bond the current collector to the at least one external tab in a mechanical and an electrical bond.

21. The cell of claim 20, wherein the cell comprises a plurality of current collectors and the mating cavity is formed in the at least one external tab and the plurality of current collectors.
